(19) United States
(12) Patent Application Publication
(10) Pub. No.: US 2013/0024520 A1
(43) Pub. Date: Jan. 24, 2013

(54) Systems And Methods For Managing Commercial Emails

(71) Applicant: James Siminoff, Pacific Palisades, CA (US)

(72) Inventor: James Siminoff, Pacific Palisades, CA (US)

(21) Appl. No.: 13/185,453

(22) Filed: Jul. 18, 2011

(51) Int. Cl. G06F 15/16

(52) U.S. Cl. 709/206

(57) ABSTRACT

Systems, methods and software products manage a commercial email message by (a) intercepting, within add-in software installed into an email client of a user, a request to send the commercial email message addressed to an addressee, (b) searching for an email address of the addressee within an unsubscribe list, and (c) if the email address is found in the unsubscribe list, removing the addressee from the commercial email message prior to sending the commercial email message.

### BACKGROUND

In order to comply with the CAN-SPAM Act of 2003 as well as many international laws that are similar, email with a commercial purpose must allow the receiver to unsubscribe from it. Such emails typically provide instructions and/or a link at the bottom of the email message to allow the recipient to unsubscribe.

Such emails are usually sent from Email Service Providers (ESPs) that provide platforms and services for sending commercial emails to companies wishing to send commercial emails. These platforms and services either send email messages directly from their servers or require expensive integration with IT infrastructure of the companies. The ESP also manages an unsubscribe list and its supporting infrastructure.

Alternatively, a company wishing to send commercial emails may develop a ‘homegrown’ system for sending the commercial emails. However, these ‘homegrown’ systems handle email in the same way as the ESP.

The ESP and the “Homegrown” system require a sender to configure the system, load an email addressee list, provide a template for the commercial emails, and initiate the sending. Such systems are designed to send large numbers of email and the email addressee list is typically very large. Such systems are not convenient or economical for use by small companies such as a real estate broker, a wealth manager, a recruiter, and so on, who typically requires small numbers of commercial email to be sent efficiently.

For example a company like Boeing might use an ESP to manage and send millions of commercial emails per year to a controlled list of email addressees of people interested in their products. However, a satellite sales guy in Florida who typically meets with people individually and managing his own small list of people with email addresses has no way convenient automated way to manage the email list and to unsubscribe email addressees from it. Such small lists cannot tie into the larger Boeing unsubscribe list, for example. The US CAN-SPAM act of 2003 specifically states that a receiver must be able to unsubscribe from ALL commercial email from a company. Current systems do not allow for that.

### SUMMARY OF THE INVENTION

In an embodiment, a system manages a commercial email message. The system includes a database storing an unsubscribe list and an add-in software, installed within an email client executing on a user's computer system. The add-in software intercepts a request to send the commercial email message and removes an addressee of the commercial email message if the addressee's email address is stored within the unsubscribe list.

In another embodiment, a method manages a commercial email message by (a) intercepting, within add-in software installed into an email client of a user, a request to send the commercial email message addressed to an addressee, (b) searching for an email address of the addressee within an unsubscribe list, and (c) if the email address is found in the unsubscribe list, removing the addressee from the commercial email message prior to sending the commercial email message.

In another embodiment, a software product has instructions, stored on non-transient computer-readable media, wherein the instructions, when executed by a computer, perform steps for managing a commercial email message. The software product includes instructions within add-in software installed into an email client of a user for intercepting a request to send the commercial email message addressed to an addressee, instructions for searching for an email address of the addressee within an unsubscribe list, and instructions for removing the addressee from the commercial email message prior to sending the commercial email message if the email address is found in the unsubscribe list.

### BRIEF DESCRIPTION OF THE FIGURES

FIG. 1 shows one prior art commercial email management system.

FIG. 2 shows one exemplary system for managing a commercial email, in an embodiment.

FIG. 3 shows one exemplary method for managing a commercial email, in an embodiment.

### DETAILED DESCRIPTION OF THE EMBODIMENTS

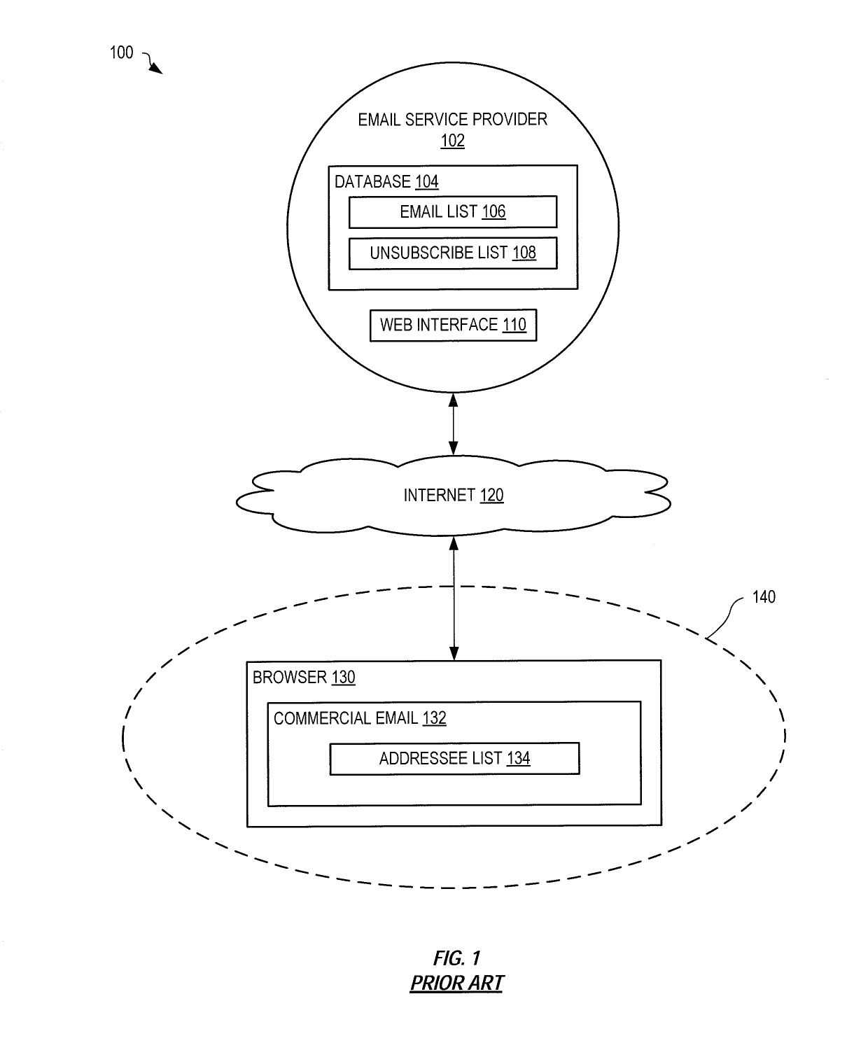

FIG. 1 shows one prior art commercial email management system 100. System 100 is typically implemented by an email service provider 102 that utilizes a database 104 to store and manage an email list 106 and an unsubscribe list 108. System 100 is typically used by a large organization 140 that frequently sends a commercial email 132 to a large number of addressees. A user of system 100 within organization 140 accesses email service provider 102 via the Internet 120 using a browser 130 to create commercial email 132 that has an addressee list 134 selected from email list 106 within database 104 of email service provider 102. Email service provider 102 also maintains an unsubscribe list 108 of addressees that have requested to be removed from future commercial emails from organization 140. For example, upon receiving commercial email 132 from organization 140, an addressee may reply to the email with a subject line containing the work “UNSUBSCRIBE”, wherein email service provider 102 automatically adds the addressee to unsubscribe list 108 and ultimately removes the addressee from email list 106.

Specifically, the user within organization 140 is required to generate commercial email 132 using a mechanism that operates externally to conventional email clients, and system 100 provides no protection against other emails being sent from organization 140 to an addressee that has requested removal from future commercial emails. In view of legislation, emails send to an addressee that has requested removal from address lists for commercial emails may result in a fine imposed upon organization 140. Further, email list 106 is typically purchased from a third party and loaded directly into email service provider 102 and is therefore not directly controlled by organization 140. Email service provider 102 may not provide a mechanism for direct access to email list 106 such that organization 140 is unable to add and/or remove an addressee to/from email list 106.

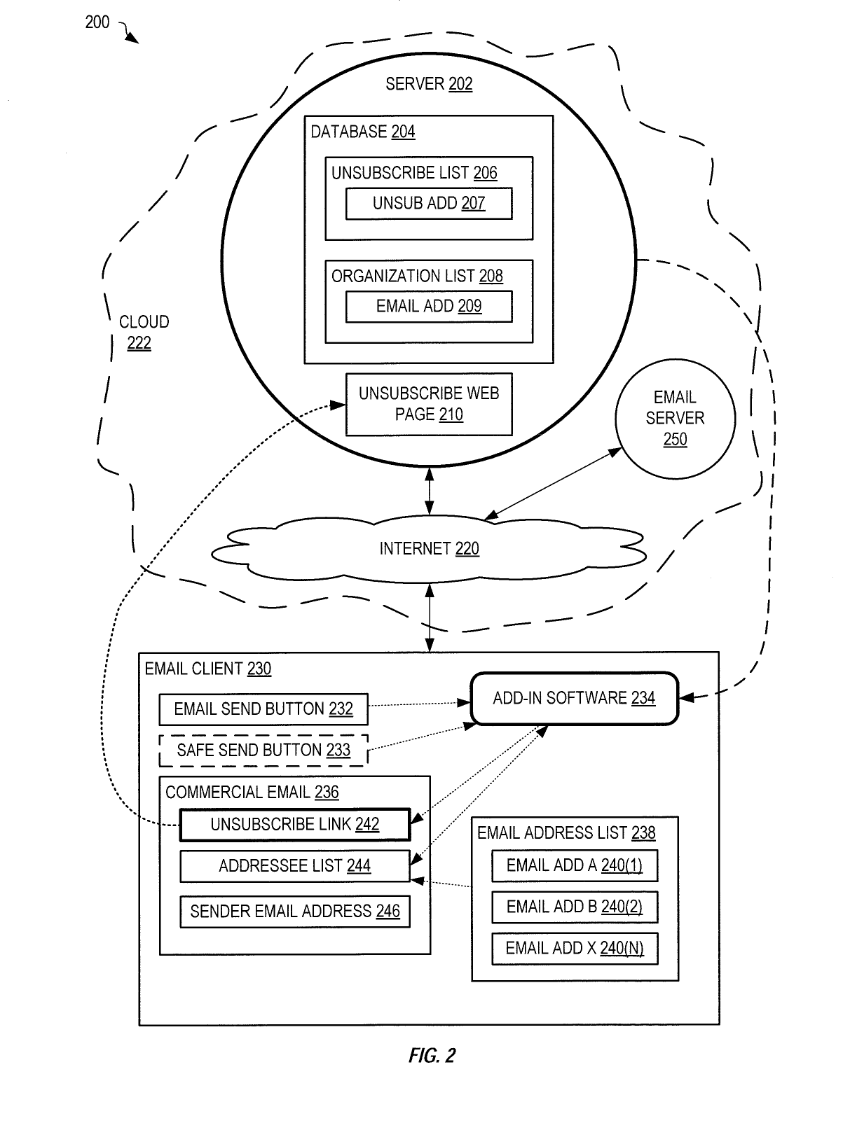

FIG. 2 shows one exemplary system 200 for managing commercial email 236. Server 202 has a database 204, which includes an organization list 208 and an unsubscribe list 206, and provides an unsubscribe web page 210. In one embodiment, unsubscribe list 206 is stored external to, and accessible by, server 202. For example, server 202 may contain a link to another server that stores and provides access to unsubscribe list 206. Server 202 may be accessed through Internet 220 and may be considered part of computing cloud 222 (i.e., a cloud based service). Cloud computing means using a network of remote servers hosted on the Internet to store, manage, and process data, rather than a local server or personal computer.

A user (or group of associated users, such as from a common organization or company) registers with server 202 and adds their email address 209 to organization list 208 in association with unsubscribe list 206. For example, email address 209 may be associated with unsubscribe list 206 within database 204. Server 202 may store and maintain multiple unsubscribe lists within database 204. Within organization list 208, email addresses may be grouped together where users cooperate to send commercial emails and share unsubscribe list 206. Unlike with conventional email service providers (e.g., email service provider 102), grouping of users is not based upon a domain name within email addresses. Optionally, grouping of users by domain name may be enabled for large organizations. The user installs add-in software 234 into email client 230 to intercept a send action for commercial email 236 prior to sending the email from email client 230. Each user installs add-in software 234 within their email client 230.

Add-in software 234 analyzes commercial email 236 to determine whether it complies with legal requirements for commercial email messages (e.g., that commercial email 236 allows a recipient to unsubscribe from future email messages and that any unsubscribed addressee is removed from addressee list 244 of commercial email 236). In one embodiment, add-in software 234 intercepts all email send actions within email client 230, such as when the user clicks on email send button 232 within email client 230.

In an alternative embodiment, add-in software 234 provides an additional “safe send” button 233 that the user may click when sending commercial email 236 that directly invokes add-in software 234 to make the email comply with legal requirements prior to sending from email client 230. Optionally, add-in software 234 analyzes each email sent from email client 230 (even when a safe send button is installed but not used), to identify commercial emails (e.g., commercial email 236) and asks the user whether the email should be made to comply with legal requirements. For example, add-in software 234 may identify commercial emails as (a) having addressee's with domains that are different from the sender's domain, (b) having a number of addressee within addressee list 244 greater than a predefined threshold (e.g., 6), and (c) by the number of different domains of addressees within addressee list 244 being greater than a predefined threshold (e.g., 3).

Add-in software 234 generates, based upon sender email address 246, an unsubscribe link 242 (e.g., a URL) to unsubscribe web page 210 that is maintained by server 202. In one embodiment, unsubscribe web page 210 is provided by an external web page server that is external, but in communication with, server 202. Unsubscribe link 242 may include information such as sender email address 246 and upon selection by a recipient of commercial email 236, the recipients email address. Unsubscribe web page 210 adds the received recipient's email address (shown as unsubscribe address 207) to unsubscribe list 206 based upon the received sender email address 246. That is, the unsubscribe address 207 is added to unsubscribe list 206 associated with the sender of commercial email 236.

In one example of operation, a user creates commercial email 236 within email client 230 and includes addressee list 244 from their local email address list 238. Email client 230 automatically adds sender email address 246 to commercial email 236 and the user creates and adds the contents of the message. Add-in software 234 intercepts an email send action that occurs for example when the user clicks on email send button 232 (or optionally when the user clicks on safe send button 233). Add-in software 234, in cooperation with server 202, removes any addressee from addressee list 244 that also appears within unsubscribe list 206 and adds unsubscribe link 242 to commercial email 236. Commercial email 236 is then sent from email client 230 to email server 250 for example for delivery to each recipient (addressee) listed in addressee list 244.

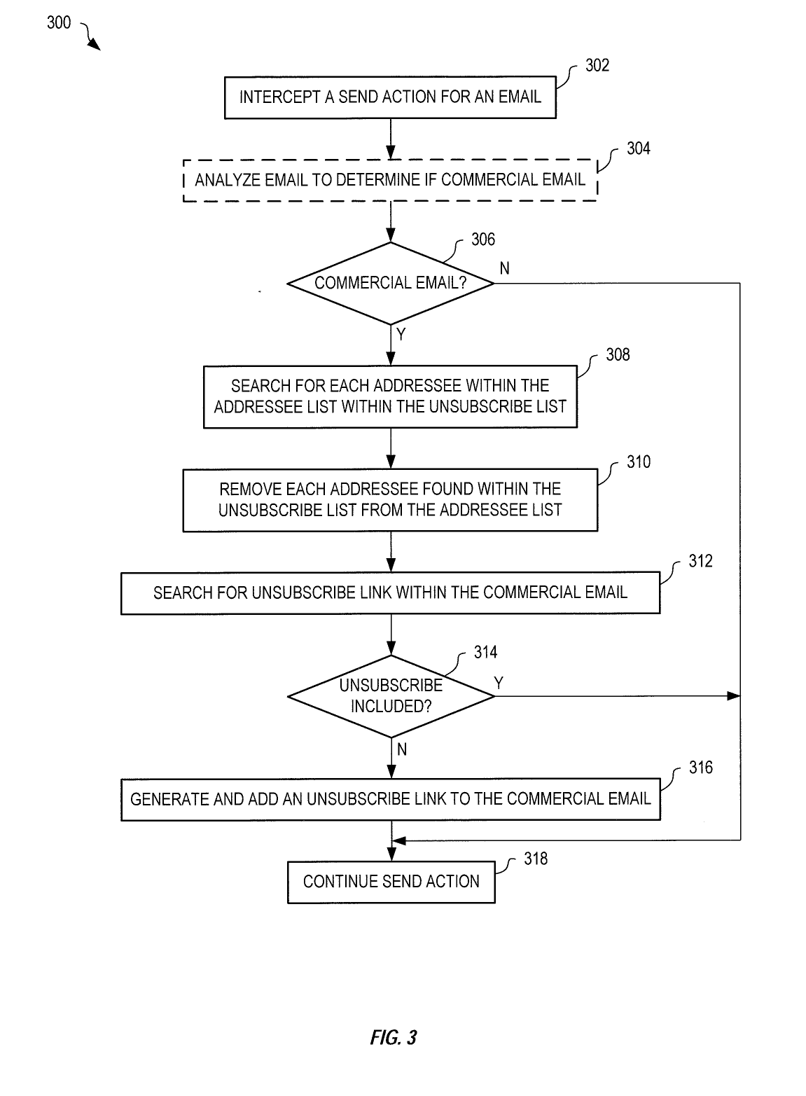

FIG. 3 shows one exemplary method 300 for managing a commercial email. Method 300 is implemented within one or both of add-in software 234 and server 202. In step 302, method 300 intercepts a send action for an email. In one example of step 302, within email client 230, add-in software 234 intercepts a click on email send button 232 by a user of email client 230. Step 304 is optional. In step 304, if included, method 300 analyzes the email to determine if it is a commercial email. In one example of step 304, add-in software 234 analyzes each email message to be sent by email client 230 to determine the number of recipients and whether the recipients are of the same organization (e.g., domain) as the sender, wherein the email may be considered commercial if there are multiple recipients that are not within the sender's organization.

Step 306 is a decision. If, in step 306, method 300 determines that the email is a commercial email, method 300 continues with step 308; otherwise method 300 continues with step 318.

In step 308, method 300 searches for each addressee with the addressee list within the unsubscribe list. In one example of step 308, add-in software 234 sends sender email address 246 and addressee list 244 to server 202, wherein server 202 searches within unsubscribe list 206 associated with sender email address 246 for each addressee and returns an indication as to whether the addressee was found to add-in software 234.

In step 310, method 300 removes each addressee found in the unsubscribe list from the addressee list. In one example of step 310, add-in software removes each addressee indicated as found within unsubscribe list 206 from addressee list 244 of commercial email 236.

In step 312, method 300 searches for an unsubscribe link within the commercial email. In one example of step 312, add-in software 234 searches within commercial email 236 for unsubscribe link 242.

Step 314 is a decision. If, in step 314, method 300 determines that an unsubscribe link is included within the commercial email, method 300 continues with step 318; otherwise method 300 continues with step 316.

In step 318, method 300 generates and adds an unsubscribe link to the commercial email. In one example of step 316, add-in software 234 generates unsubscribe link 242 based upon sender email address 246 and adds unsubscribe link 242, and optionally appropriate text, to commercial email 236.

In step 318, method continues the send action that was intercepted in step 302. In one example of step 318, add-in software 234 returns control to email client 230 wherein the send action intercepted in step 302 continues and commercial email 236 is sent from email client 230.

System 200 of FIG. 2 may also be used in conjunction with other suppression lists to ensure that one group within a company does not send emails to an addressee that has unsubscribed from other groups within the same company.

In one embodiment, system 200 searches, for each non-commercial email being sent from email client 230, for each addressee within unsubscribe list 206. If the addressee is found within unsubscribe list 206, the uses is asked whether the email may be considered commercial. If the user responds no, then the email is sent, otherwise the addressee is automatically removed from addressee list 244 or the email is blocked to maintain compliance with legal requirements.

In one embodiment, add-in software 234 intercepts recipient email addresses as they are being input into commercial email 236, performs a search for each input email address within unsubscribe list 206 and flags and/or marks the addressee that are found within addressee list 244. Thus, the user is made aware of unsubscribed email addresses prior to send commercial email 236.

Changes may be made in the above methods and systems without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A system for managing a commercial email message, comprising:
a database storing an unsubscribe list; and
add-in software, installed within an email client executing on a user's computer system, for:
intercepting a request to send the commercial email message; and
removing an addressee of the commercial email message if the addressee's email address is stored within the unsubscribe list.

2. The system of claim 1, the add-in software adding, to the commercial email, an unsubscribe link for adding an email address of a recipient of the commercial email message to the unsubscribe list when the recipient clicks on the unsubscribe link.

3. The system of claim 2, further comprising a server accessible through the Internet for displaying a web page within a browser of the recipient when the recipient clicks on the unsubscribe link, wherein the web page adds the email address of the recipient to the unsubscribe list.

4. The system of claim 1, further comprising a server that is accessible through the Internet and which provides the add-in software with access to the database.

5. The system of claim 1, further comprising an unsubscribe web page that is displayed within a browser of a recipient of the commercial email message when the unsubscribe link is clicked on, wherein the web page adds an email address of the recipient to the unsubscribe list.

6. A method for managing a commercial email message, comprising:
intercepting, within add-in software installed into an email client of a user, a request to send the commercial email message to an addressee;
searching for an email address of the addressee within an unsubscribe list; and
if the email address is found in the unsubscribe list, removing the addressee from the commercial email message prior to sending the commercial email message.

7. The method of claim 6, further comprising:
sending, from the add-in software to a server, the email address of the addressee and identification of the user; and
selecting, within the server, the unsubscribe list based upon the identification;
wherein the step of searching is performed within the server.

8. The method of claim 6, further comprising installing a safe send button within the email client to generate the request to send when the user clicks on the safe send button.

9. The method of claim 6, further comprising:
adding an unsubscribe link to the commercial email message; and
providing a web page that is accessed when a recipient of the commercial email message clicks on the unsubscribe link;
wherein the web page adds an email address of the recipient to the unsubscribe list when accessed.

10. A software product comprising instructions, stored on non-transient computer-readable media, wherein the instructions, when executed by a computer, perform steps for managing a commercial email message, comprising:
instructions within add-in software installed into an email client of a user for intercepting a request to send the commercial email message to an addressee;
instructions for searching for an email address of the addressee within an unsubscribe list; and
instructions for removing the addressee from the commercial email message prior to sending the commercial email message if the email address is found in the unsubscribe list.

11. The software product of claim 10, further comprising:
instructions for sending, from the add-in software to a server, the email address of the addressee and identification of the user; and
instructions for selecting, within the server, the unsubscribe list based upon the identification;
wherein the instructions for searching are executed within the server.

12. The software product of claim 10, further comprising instructions for installing a safe send button within the email client to generate the request to send when the user clicks on the safe send button.

13. The software product of claim 10, further comprising:
instructions for adding an unsubscribe link to the commercial email message; and
instructions for providing a web page that is accessed when a recipient of the commercial email message clicks on the unsubscribe link;
wherein the web page adds an email address of the recipient to the unsubscribe list when accessed.
